(19) United States
(12) Patent Application Publication
(10) Pub. No.: US 2009/0119117 A1
(43) Pub. Date: May 7, 2009

(54) SUPPLYING PRE-SORT DISCOUNT RATE DATA TO POSTAGE METER

(75) Inventors: Alexandra Mack, Monroe, CT (US); Thomas J. Foth, Trumbull, CT (US); Christopher M. Giles, Monroe, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Inc., Shelton, CT (US)

(21) Appl. No.: 11/935,444

(22) Filed: Nov. 6, 2007

(51) Int. Cl. G06Q 30/00; B07C 3/00; G07B 17/02

(52) U.S. Cl. 705/1; 209/584; 705/402

(57) ABSTRACT

A method includes receiving, in a postage meter, input from a user to select a rate option in the postage meter for mail that is to be pre-sorted at a remote location. If the selected pre-sort rate option has been programmed into the postage meter, the postage meter is set to print postage indicia in accordance with the selected pre-sort rate option. If the selected pre-sort rate option has not been programmed into the postage meter, the postage meter displays, to the user, information to indicate to the user how to arrange for the selected pre-sort rate option to be programmed into the postage meter.

### FIELD OF THE INVENTION

The invention disclosed herein relates generally to mail processing and more particularly is concerned with operating a postage meter in relation to mail that is to be dispatched to a “pre-sort house” for processing prior to induction to a postal authority.

### BACKGROUND

Some postal authorities, such as the U.S. Postal Service (USPS), have pursued policies that encourage so-called “work sharing” with mailers. One aspect of work sharing is that mailers are given rate incentives with respect to batches of mail for which some of the processing tasks such as pre-sorting or barcoding are performed prior to inducting the batches of mail into the USPS. The existence of pre-sort rate discounts has permitted the establishment of “pre-sort houses”. A pre-sort house is engaged by a mailer to receive a batch of mail, from the mailer, in a non-pre-sorted condition. The pre-sort house applies (usually automatic) pre-sorting to the batch of mail and then delivers the mail to the USPS. The benefit of the rate discount achieved by the pre-sorting is shared by the mailer and the pre-sort house.

The present inventors have recognized that there are opportunities to improve the interaction between mailers and pre-sort houses. At least some of these improvements are related to the mailers' operation of postage meters that are used to make postage payments for batches of mail to be pre-sorted by pre-sort houses.

### SUMMARY

According to an aspect of the invention, a method includes receiving, in a postage meter, input from a user to select a rate option in the postage meter for mail that is to be pre-sorted at a remote location. If the selected pre-sort rate option has been programmed into the postage meter, the postage meter is set to print postage indicia in accordance with the selected pre-sort rate option. If the selected pre-sort rate option has not been programmed into the postage meter, information is displayed to the user on the meter's display device. The information indicates to the user a process step for programming the selected pre-sort rate option into the postage meter.

The information may include a notice to contact a service provider that has a capability to program the selected rate option into the postage meter. The information may include the telephone number and/or the website address for the service provider. The selected rate option may be a pre-sort discount rate option.

According to another aspect of the invention, a method includes sorting a batch of letters. Each letter bears a respective postage meter indicium. The method further includes reading at least one of the postage meter indicia to identify a mailer that generated the batch of letters. The method also includes dispatching the sorted batch of letters to a postal authority such as the USPS, and reporting to the mailer the date and/or the time at which the mail was dispatched.

The method may further include reporting, to the mailer, information that identifies the batch of letters.

Reading the postage meter indicium may include reading the mailer's e-mail address from the postage meter indicium. The mailer may be identified by one or more of (a) the mailer's e-mail address, and (b) the postage meter number (included in the indicium). The reporting to the mailer may be accomplished by sending an e-mail message to the mailer and/or by posting information regarding the batch of letters on a website that is accessed by the mailer.

According to yet another aspect of the invention, a method includes receiving from a mailer a batch of letters to be pre-sorted. Each of the letters bears a postage meter indicium. The method further includes reading at least one of the indicia to identify a postage meter that printed the indicia, and responding to the reading of the indicium/indicia by transmitting postage rate data to the identified postage meter.

The method may also include a step (performed prior to the transmitting step) of determining that the postage rate data was not previously transmitted to the identified postage meter. The postage rate data transmitted may be pre-sort discount rate data. The postage rate data may be configured based on the location of the mailer (e.g., the distance of the mailer from a pre-sort house).

Therefore, it should now be apparent that the invention substantially achieves all the above aspects and advantages. Additional aspects and advantages of the invention will be set forth in the description that follows, and in part will be obvious from the description, or may be learned by practice of the invention. Various features and embodiments are further described in the following figures, description and claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is a block diagram of a system that may be provided in accordance with aspects of the present invention.

FIG. 2 is a block diagram that illustrates a postage meter that may be included in the system of FIG. 1.

FIG. 3 is a flow chart that illustrates a process that may be performed in accordance with aspects of the present invention in the postage meter of FIG. 2.

FIG. 4 is a flow chart that illustrates a process that may be performed, in accordance with aspects of the present invention, by a pre-sort house in the system of FIG. 1.

### DETAILED DESCRIPTION

The present invention, in certain of its aspects, is concerned with postage rate options that may be displayed by a postage meter. The postage rate options may include a “pre-sort” rate option. If the user selects that option, the postage meter may be set to operate based on the pre-sort rate, assuming that that rate has been programmed into the meter. If the pre-sort rate option is selected but the pre-sort rate has not been programmed into the meter, then instead of setting the meter, the meter may display a notice to the user such as, “Contact (ABC Pre-Sort House) for information about pre-sort services and pre-sort discount postal rates”. The meter may select which notice to provide based on the zip code programmed into the meter by the meter manufacturer.

In other aspects, the invention may involve activities of a pre-sort house. For example, when the pre-sort house receives a batch of mail to be pre-sorted, the pre-sort house may read a postage meter indicium on one of the letters to determine whether the mailer/postage meter is previously known to the pre-sort house's information technology systems. If not, the pre-sort house may take steps to download suitable pre-sort discount rate data to the postage meter that generated the postage meter indicium. Moreover, the pre-sort house may use e-mail and/or information posted on the pre-sort house's website to inform the mailer that the sorting of the mailer's batch of mail has been completed and the batch has been passed on to the USPS.

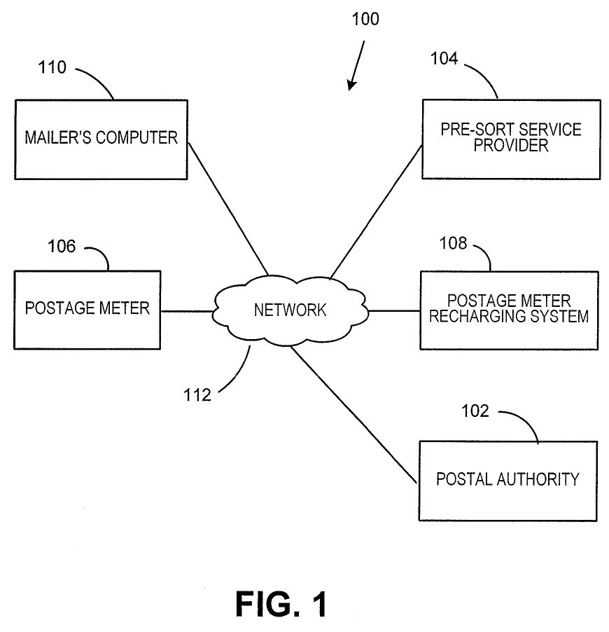

FIG. 1 is a block diagram of a system 100 that may be provided in accordance with aspects of the present invention. Block 102 in FIG. 1 represents a postal authority such as the U.S. Postal Service. Block 104 represents a pre-sort house (also known as a “pre-sort service provider”). A well known pre-sort service provider is PSI Group, Inc., which is affiliated with Pitney Bowes Inc., the assignee hereof.

Block 106 in FIG. 1 represents a postage meter that may be operated by a mailer (not separately shown) to effect payment of postage with respect to batches of mail. The batches of mail may be delivered to the pre-sort house 104 for pre-sorting and/or other processing.

Block 108 represents a system that, possibly among other capabilities, functions to download postal rate data to postage meters and/or to recharge postage meters remotely by electronic signaling. An example of such a system 108 is the Intellilink® technology system operated by the assignee hereof.

Block 110 represents a computer that may be operated by the mailer that also operates postage meter 106.

Some or all of the components of system 100 enumerated above may, at least from time to time, be in data communication with at least one other component of the system 100 via one or more data communication networks 112.

Each of the blocks 102, 104 and 108 may be considered to represent an institution or enterprise, but may also be considered to represent one or more computers operated by or on behalf of the respective institution or enterprise.

Although only one postage meter is depicted in FIG. 1, it should be understood that in practice the system 100 may incorporate a considerable number of postage meters (e.g., thousands or hundreds of thousands). Some or all of the postage meters may be in data communication, at least from time to time, with one or more of the postage meter recharging system 108, the pre-sort house 104 and the postal authority 102.

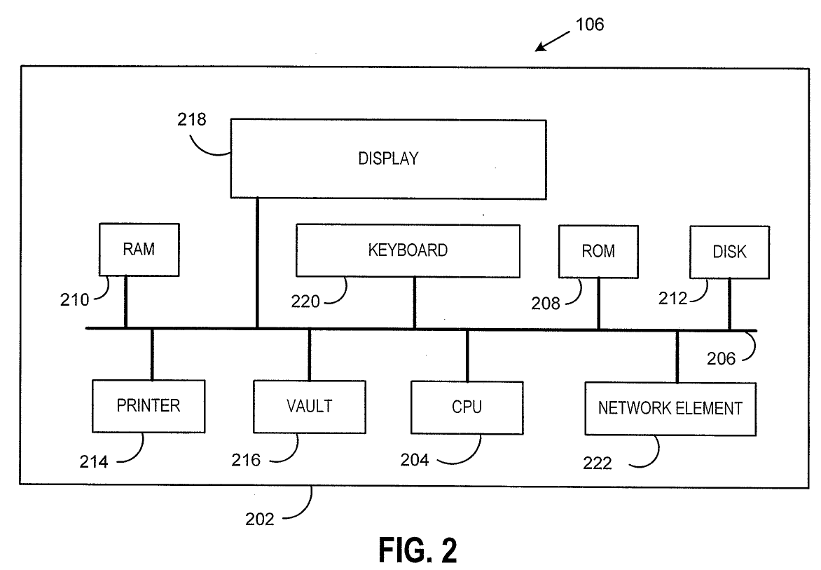

FIG. 2 is a block diagram that illustrates a typical postage meter, such as postage meter 106, that may be included in the system 100.

Postage meter 106 may include a housing 202 that supports and/or contains other components (enumerated below) of the postage meter 106. The postage meter 106 may also include a processor 204 (e.g., a conventional microprocessor or microcontroller) that controls over-all operation of the postage meter 106. Further, the postage meter 106 may include a data bus 206 to which the processor 204 is coupled.

In addition, the postage meter 106 may include a ROM (read only memory) 208 coupled to the data bus 206 and RAM (random access memory) 210 coupled to the data bus 206. ROM 208 may provide program memory (for boot code, e.g.). RAM 210 may serve, for example, as working memory and/or temporary program memory.

Still further, the postage meter 106 may include a hard disk drive 212 that is also coupled to the data bus 206. The hard disk drive 212 may, for example, serve as mass storage and/or permanent/semi-permanent storage for one or more applications or other programs that may be temporarily loaded into RAM 208 to control the processor 204.

Also, the postage meter 106 may include a printer 214 that prints postage indicia on mail pieces (not shown) and a “vault” component 216 that securely stores and disburses postage to support the printing of the postage indicia. Both the printer 214 and the vault 216 may also be coupled to the data bus 206.

Moreover, the postage meter 106 may include a user interface that comprises, for example, a display (e.g., a liquid crystal display) 218 and a keyboard 220, both also coupled to the data bus 206.

Furthermore, the postage meter 106 may include a network element 222 (e.g. a modem or an Ethernet controller) that is coupled to the data bus 206 and enables the postage meter 106 to engage in data communications with external devices.

The postage meter 106 may, in some embodiments, be entirely conventional in terms of its hardware aspects, but may be suitably programmed in accordance with aspects of the invention to function as described herein.

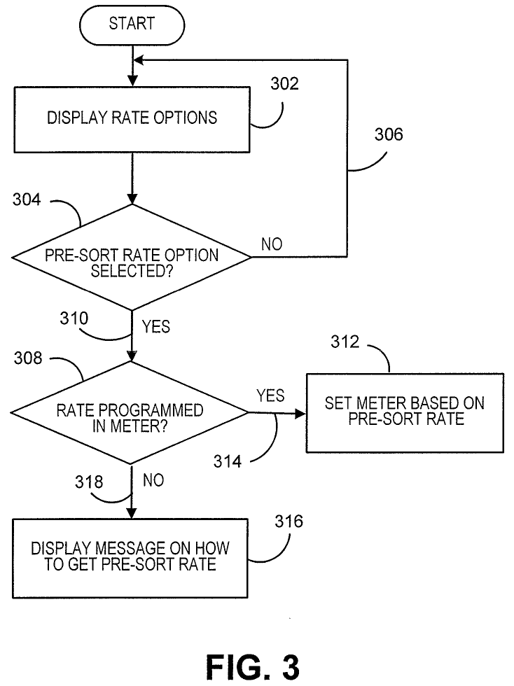

FIG. 3 is a flow chart that illustrates a process that may be performed in accordance with aspects of the present invention in the postage meter 106.

As indicated at 302 in FIG. 3, the postage meter 106 may display a number of rate options to the user via the display 218. The rate options may be displayed on the display component 218 of the meter 106 and may be presented, for example, as one item of a menu of rates to be selected to set the meter for printing postage indicia in accordance with a selected rate. One such rate option may, for example, be a pre-sort rate option. It should be understood that a pre-sort rate may be rate suitable for use with a batch of mail that is, or will in the future be, sorted so as to take advantage of pre-sort discounts offered by a postal authority such as the USPS. One other rate option that may be included in such a menu may be a regular, non-discounted first class mailing rate. The menu referred to in this paragraph may, but need not, allow the user to select other functions or features of the postage meter 106 in addition to selecting a rate for setting the postage meter 106.

A decision block 304 may follow step 302 in FIG. 3. At decision block 304, the postage meter 106 may determine whether the user has selected the above-mentioned pre-sort rate option. For example, the user may select the pre-sort rate option by actuating a suitable soft key (not separately indicated apart from keyboard 220) or otherwise by interacting with the keyboard 220.

If it is determined at 304 that the user has selected the pre-sort rate option, then the process of FIG. 3 may advance from 304 to decision block 308, as indicated by branch 310 from 304. At decision block 308, it is determined whether a pre-sort rate has been programmed into the postage meter 106. It should be noted that it may typically be the case that many postage meters installed at mailers' premises may not be utilized on pre-sorted or to-be-pre-sorted mail. Also, even for mailers that pre-sort or engage a pre-sort house to do so, the appropriate pre-sort rate level may vary from mailer to mailer. Accordingly, it may be an appropriate practice not to customarily program a pre-sort rate into at least some models of postage meters. Thus, some postage meters may have a pre-sort rate programmed therein, and others may not.

If it is determined at 304 that the user has not selected the pre-sort rate option, the process of FIG. 3 may advance from 304 to step 320, as identified by the branch 322 from 304. In step 320 the meter will process the mail as appropriate for the selected rate. For example, the user may provide other input, such as selecting a non-discounted first class rate option, and the postage meter may respond by taking other actions, such as being set to meter mail based on the non-discounted first class rate.

If it is determined at 308 that a pre-sort rate has been programmed into the postage meter, then the process of FIG. 3 advances from 308 to 312, as indicated by branch 314 from 308. At 312, the postage meter is set to meter mail (i.e., to print postage indicia on mail pieces and deduct postage from the postage amount stored in the vault 216) in accordance with the selected pre-sort rate.

If it is determined at 308 that no pre-sort rate has been programmed into the postage meter, then the process of FIG. 3 advances from 308 to 316, as indicated by branch 318 from 308. At 316, the postage meter 106 may display a message or other information to the user via the display 218. For example, the message may advise the user of one or more steps that the user may take to have a pre-sort rate programmed into the postage meter 106. Such a message may, for example, advise the user to contact pre-sort house 104 (FIG. 1). For example, the message may say something like “Contact (Presort House) to learn more about pre-sort discounted postage rates”. The message may also contain either or both of a telephone number and a website address for the pre-sort house 104.

Assuming in such a case that the user contacts the pre-sort house 104, the mailer that operates the postage meter 106 may enter into a business relationship with the pre-sort house. Pursuant to the business relationship with the mailer, the pre-sort house 104 may contact the postage meter recharging system 108 to cause the postage meter recharging system 108 to download suitable pre-sort rate data to the postage meter 106, thereby programming the pre-sort rate into the postage meter 106. Consequently, on subsequent occasions when the pre-sort rate option is selected in the postage meter 106, the meter 106 may be set to meter mail at the pre-sort rate, and the message referred to in connection with 316 may not be displayed on the subsequent occasions.

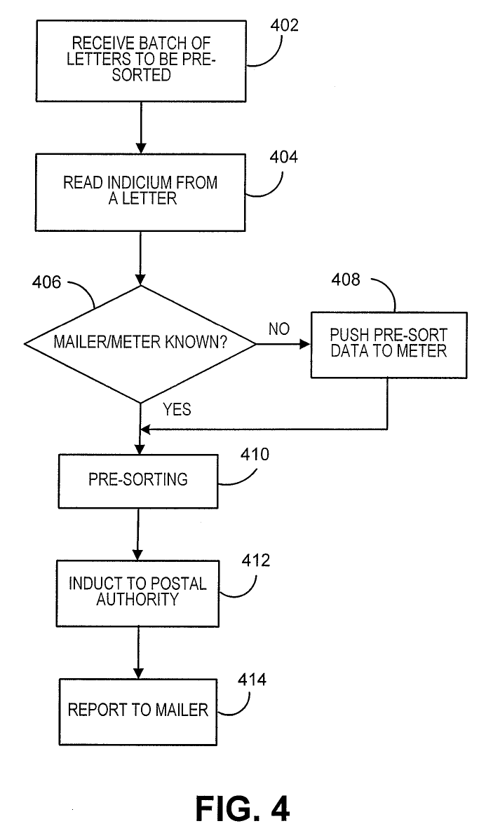

FIG. 4 is a flow chart that illustrates a process that may be performed (at least in part) by the pre-sort house 104 in the system 100.

At 402, the pre-sort house 104 receives a batch of letters that it is to pre-sort. It is assumed that the letters have been metered by postage meter 106, so that each of the letters carries a respective postage indicium printed thereon by the postage meter 106. It will also be assumed that each indicium is of the sort prescribed by the information based indicia program (IBIP) promulgated by the USPS. According to this assumption, each indicium includes a two-dimensional barcode from which various information can be read. The information includes, for example, the unique identification number (meter serial number) for the postage meter 106.

At 404, the pre-sort house reads the respective indicium from at least one letter of the batch of letters received at 402. It will be appreciated that appropriate scanning equipment (e.g., a hand-held scanner or an automatic scanner) may be employed to read the indicium. In some cases, the pre-sort house may read the respective indicium on every letter in the batch of letters.

A decision block 406 may follow 404. At decision block 406 it is determined whether the pre-sort house has a record of the particular postage meter that metered the batch of mail received at 402. For example, this determination may be made by a computer (not separately shown) operated by the pre-sort house and coupled to the scanner referred to in connection with 404. For example, the pre-sort house computer may make this determination by comparing the postage meter identification number read at 404 with a roster of postage meter numbers stored in the computer. If a negative determination is made at 406 (e.g., if the postage meter number read at 404 is not in the roster of postage meter numbers stored in the pre-sort house computer), the pre-sort house computer may conclude that this is the first batch of letters ever received by the pre-sort house from the particular postage meter in question. The process of FIG. 4 may then advance from 406 to 408. At 408 the pre-sort house 104 may communicate with the postage meter recharging system 108 to cause the postage meter recharging system to download suitable pre-sort rate data to the postage meter 106 that metered the batch of letters received at 402. In some embodiments, the actual pre-sort rate downloaded to the meter may vary from mailer to mailer, depending for example on the location of the mailer (e.g., depending on the mailer's distance from the pre-sort house).

Following 408 (or directly following 406 if at 406 it is found that the postage meter that metered the batch of letters is not new to the pre-sort house) is step 410. At 410, the pre-sort house 410 pre-sorts the batch of letters 410. This may be done in accordance with conventional practices.

Once the batch of letters has been pre-sorted, and following any other necessary processing, the pre-sort house may dispatch the batch of letters to the USPS by, for example, loading the batch of letters on a vehicle and transporting the batch of letters to a USPS facility, where the batch of letters is inducted into the USPS mailstream. The step of dispatching the batch of letters is indicated at 412 in FIG. 4.

At 414 in FIG. 4, the pre-sort house reports to the mailer that the batch of letters has been dispatched. The report may include, for example, the date and time at which the dispatching of the batch of letters occurred. The report may for example be made by sending an e-mail message to the mailer's computer 110 (FIG. 1). The pre-sort house may have read the necessary e-mail address from the postage meter indicium on one of the letters as part of step 404. In addition or alternatively, the pre-sort house may have posted the report of dispatching the batch of mail on a website that is operated by the pre-sort house and accessible by the mailer. As still another alternative, the pre-sort house may send the report to the mailer via fax.

In some embodiments, when a mailer selects the pre-sort rate option on his/her postage meter, and then uses the postage meter to meter a batch of mail, the postage meter may automatically notify the pre-sort house (e.g., by e-mail) to come to the mailer's facility to pick up the batch of mail for pre-sorting by the pre-sort house.

The method steps described herein need not be performed in the order set forth above. Rather, the steps may be performed in any order that is practicable.

A number of embodiments of the present invention have been described. Nevertheless, it will be understood that various modifications may be made without departing from the spirit and scope of the invention. Other variations relating to implementation of the functions described herein can also be implemented. Accordingly, other embodiments are within the scope of the following claims.

What is claimed is:

1. A method comprising:
receiving, in a postage meter, input from a user to select a rate option in the postage meter for mail that is to be pre-sorted at a remote location;
if the selected pre-sort rate option has been programmed into the postage meter, setting the postage meter to print postage indicia in accordance with the selected pre-sort rate option; and
if the selected pre-sort rate option has not been programmed into the postage meter, displaying, to the user, on a display device that is part of the postage meter, information to indicate to the user a process step for programming the selected pre-sort rate option into the postage meter.

2. The method according to claim 1, wherein the information includes a notice to contact a service provider, the service provider having a capability to program the selected pre-sort rate option into the postage meter.

3. The method according to claim 2, wherein the information includes a telephone number of the service provider.

4. The method according to claim 2, wherein the information includes an address of a website of the service provider.

5. The method according to claim 2, wherein the information to be displayed to the user is selected based on a zip code programmed into the postage meter.

6. A method comprising:
sorting a batch of letters, each letter bearing a respective postage meter indicium;
reading at least one of the postage meter indicia to identify a mailer that generated the batch of letters;
dispatching the sorted batch of letters to a postal authority; and
reporting to the identified mailer at least one of a date and a time at which the dispatching step was performed.

7. The method according to claim 6, further comprising:
reporting, to the identified mailer, information that identifies the batch of letters.

8. The method according to claim 6, wherein the reading includes reading the mailer's e-mail address from the at least one postage meter indicium.

9. The method according to claim 8, wherein the mailer is identified only by said e-mail address.

10. The method according to claim 8, wherein said reporting is accomplished by sending an e-mail message to the mailer.

11. The method according to claim 6, wherein said reporting is accomplished by sending an e-mail message to the mailer.

12. The method according to claim 6, wherein said reporting is accomplished by posting information regarding said sorted batch of letters on a website that is accessed by the mailer.

13. The method according to claim 6, wherein the mailer is identified by a number that identifies a postage meter that printed said indicia.

14. A method comprising:
receiving from a mailer a batch of letters to be presorted, each of said letters bearing a postage meter indicium;
reading at least one of said indicia to identify a postage meter that printed said indicia; and
responding to the reading of said at least one indicium by transmitting postage rate data to the identified postage meter.

15. The method according to claim 14, further comprising:
prior to said transmitting step, determining that said postage rate data was not previously transmitted to the identified postage meter.

16. The method according to claim 14, wherein the transmitted postage rate data is pre-sort discount rate data.

17. The method according to claim 14, wherein the postage rate data is configured based on a location of the mailer.
